(19) United States
(12) Patent Application Publication
(10) Pub. No.: US 2019/0107246 A1
(43) Pub. Date: Apr. 11, 2019

(54) APPARATUS FOR SECURING ITEMS TO A DECK

(71) Applicant: Allen L. Lindsay, Indialantic, FL (US)

(72) Inventor: Allen L. Lindsay, Indialantic, FL (US)

(21) Appl. No.: 15/729,653

(22) Filed: Oct. 10, 2017

(51) Int. Cl. F16M 13/02

(52) U.S. Cl. CPC F16M 13/02

(57) ABSTRACT

An anchor and anchoring system for securing items such as deck furniture to a surface, such as a deck surface. An anchor of the invention comprises an elongate body, a tightening element, and an optional load spreader. The elongate body of the anchor may comprise a lower elongate member having an upper surface, and a feature for tightening the upper elongate member surface against the bottom of a deck board. The lower elongate member passes through an opening between deck boards, is rotated and is then tightened against a lower surface of the deck boards. An anchoring system of the invention may comprise one or more anchors attached to an item to be secured to a deck by one or more tensioning members having a first end attached to an anchor attachment member and having a second end attached to an attachment member on the item to be secured.

### CROSS REFERENCE TO RELATED APPLICATIONS AND INCORPORATION BY REFERENCE

[Not applicable]

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

### 1. Field of the Invention

The field of the invention relates generally to systems and methods for securing items to a deck. An exemplary application of the invention is the securing of deck furniture, such as for example deck chairs, to a deck or dock.

### 2. Background Art

It is common that decks, docks or other structures may be used as a surface upon which items such as furniture may be placed. A commonplace example is the placement of deck chairs or tables on a deck or dock to make the space more livable and inviting to users. Such decks or docs may comprise an upper surface upon which the furniture rests, and it is common that such services be located out of doors such as, for example, docks over water, decks, or other outdoor living spaces. A common problem encountered in such applications occurs when wind, rain, or other outdoor elements act upon the deck furniture in such a manner as to dislocated, or remove it from the deck surface altogether. Likewise, there are numerous other applications in which it is desired to secure item upon the surface to prevent it from being displaced by forces that may act upon it.

It is often desired that such deck furniture or other items to be secured should be easily movable from one location to another location on a deck or other surface in order to satisfy the needs or desires of the user. A common problem with the use of standard hardware for the securing of deck furniture or other items to be secured onto the surface of a deck is that many decks comprise deck boards that are spaced apart by an opening. The opening, in many cases, allows the hardware used to secure the items to accidentally slip between the boards, falling through the opening, to be lost in the space underneath the deck. In many cases the deck may overhang a body of water or open space such as a ravine or natural area, causing the complete loss of the hardware that was intended for securing the deck furniture or other items to be secured. Another common problem of the use of common hardware to secure deck furniture or other items to be secured onto the surface of a deck is that it is not easy to rotate the secured deck furniture if it is, for example, directly secured to the deck surface by threaded fasteners. Often it is desired to rotate such deck furniture in order to position it at an advantageous orientation relative to the sun or wind, or to take advantage of a particular view of the environment. It is desirable that such rotation be enabled without the use of tools, the removal of fastening hardware, or the like.

There is therefore a need in the art for a system and method for securing items to be secured on the surface such that the items are prevented from unwanted displacement due to, for example, w wind or rain, while at the same time allowing the items to be secured to be easily moved from one location to another on the surface, and preventing the loss of the apparatus of the system by accidental dropping of the components of the apparatus through gaps between structural elements of the surface, for example, through openings between boards in a deck or other surface upon which the item is secured.

### BRIEF SUMMARY OF THE INVENTION

The present invention comprises an apparatus and method that have one or more of the following features and/or steps, which alone or in any combination may comprise patentable subject matter.

The present invention overcomes the shortcomings of the prior art in that it prevents unwanted displacement of items to be secured, such as deck or patio furniture, while at the same time allowing a user to rearrange such deck or patio furniture without extensive time or special tooling required.

In accordance with one embodiment of the present invention, the invention comprises an anchor for securing items to a surface. The anchor may comprise an elongate body having an axis and a first end and a second end, wherein the first end comprises an attachment member and the second end comprises a lower elongate member extending away from the elongate body axis. The elongate body may further comprise a male threaded portion, and the anchor may further comprise a tightening member having an opening therethrough, the opening comprising female threads for threading engagement with the tightening member. In use, the elongate anchor body and lower elongate member may be of such dimension that they are narrower than a gap between boards or other structures comprising the deck surface such that they may pass through the gap between boards, where upon the anchor may be rotated such that the lower elongate member prevents the anchor from being removed from between the boards. The tightening member may then be rotated so that it is motivated in a downward position on the threading engagement with the elongate anchor body, where comes into contact with an upper surface of the deck boards either directly or by way of a load spreader. The anchor elongated body may have an attachment point, which may be an eye, on an upper end. A tensioning member having two ends may be attached to the anchor attachment point on one end, and attached to an item to be secured on its other end. A plurality of anchors and tensioning members may be utilized to form an anchor system of the invention for securing an item to a deck or other surface.

Additionally, the lower elongate anchor member is further defined as extending away from the anchor axis bilaterally and the tensioning member may be further defined as a wing nut. The anchor may further include a load spreader such as a washer disposed between the lower elongate member and the tightening member. The elongate body, attachment eye and elongate lower member may each be further defined as being fabricated from stainless steel. The elongate body may be attached to the attachment member by welding, and likewise the elongate body and lower elongate member may be attached to one another by welding.

The anchor and anchor system of the invention is able to be installed and removed without the use of tools, is adaptable to various types of surfaces, is able to be quickly assembled, removed and reassembled as necessary to reposition items to be secured to surface such as a deck or dock. The anchor and anchor system of the invention overcome the shortcomings of the prior art in that the elements of the invention are prevented from being lost by accidental dropping of the components of the apparatus through openings between structural elements of the surface, for example, through openings between boards in a deck or other surface. Furthermore, the anchor and anchor system of the invention overcome the shortcomings of the prior art in that they allow for the rotation of deck furniture, or other items to be secured to a surface, in order to position it at an advantageous orientation relative to the sun or wind, or to take advantage of a particular view of the environment, without the use of any tools, any repositioning of the anchors, by simple lifting the item to be secured against the force of the tension member, rotating the deck furniture into a desired orientation, and returning the deck furniture to rest on the deck surface.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating the preferred embodiments of the invention and are not to be construed as limiting the invention. In the drawings:

FIG. 1 depicts a cross section view of an embodiment of an anchor of the invention installed on a dock or deck, or other surface having a substrate comprising openings through which the anchor may be disposed as depicted in the figure.

FIG. 2 depicts a perspective view of an embodiment of an anchor of the invention.

FIG. 3 depicts a perspective view of an alternate embodiment of an anchor of the invention.

FIG. 4A depicts a front view of an embodiment of an anchor of the invention.

FIG. 4B depicts a side view of an embodiment of an anchor of the invention.

FIG. 5A depicts a front view of an alternate embodiment of an anchor of the invention.

FIG. 5B depicts a side view of an alternate embodiment of an anchor of the invention.

FIG. 6 depicts a side view of the anchor system of the invention in a typical use securing a deck chair to the upper surface of a deck or dock.

FIG. 7 depicts an expanded view of an embodiment of the anchor system of the invention in a typical use securing a deck chair to the upper surface of a deck or dock, and depicting in larger detail the anchor system of the invention attachment to a lower surface of a seat of the deck chair.

FIG. 8 depicts a view of a typical use of the anchors and anchor system of the invention, showing the resulting forces provided by the anchors and anchor system of the invention resisting environmental forces and preventing displacement or rotation of the deck chair.

### DETAILED DESCRIPTION OF THE INVENTION

The following documentation provides a detailed description of the invention.

Although a detailed description as provided in the attachments contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention. Thus the scope of the invention should be determined by the appended claims and their legal equivalents, and not merely by the preferred examples or embodiments given.

As used herein, “tensioning member” includes within its meaning a member having two ends that is able to provide a tension force at both of its ends. The tensioning member may be comprised of various embodiments that provide this tension force. For example the tensioning member may be an element of an elastic nature such as a bungee cord or rubber cord or band member. “Bungee” includes within its meaning any nylon-cased elastic band or plurality of elastic bands. The elastic band or plurality of elastic bands may comprise rubber or any other elastic material. The tensioning member may also comprise a tension spring, either alone or in combination with elastic members, non-elastic members, or both. The tensioning member may comprise a non-elastic material such as a rope, chain, wire, cable or strap that is tightened using a tensioning feature so as to provide a tension force at both its ends. Still further, the tensioning member may be comprised of a non-elastic material as described above and further may comprise a buckle, pulley and jam cleat combination, or ratcheting strap tightener for providing the tension force in the tensioning member. Still further, the tensioning member may be comprised of an elastic member or plurality of members in combination with a non-elastic member or plurality of members, in any combination. Not all tensioning members of an anchor system of the invention need be comprised of the same materials or combination of materials.

As used herein, “wing nut” includes within its meaning a body having a female threaded opening passing therethrough and further comprising at least one, but preferably a pair, of projections enabling a user to rotate the wing nut in a threaded engagement with a male threaded body having complimentary threads, such as, in the present case, the threaded portion M of elongate body 001′.

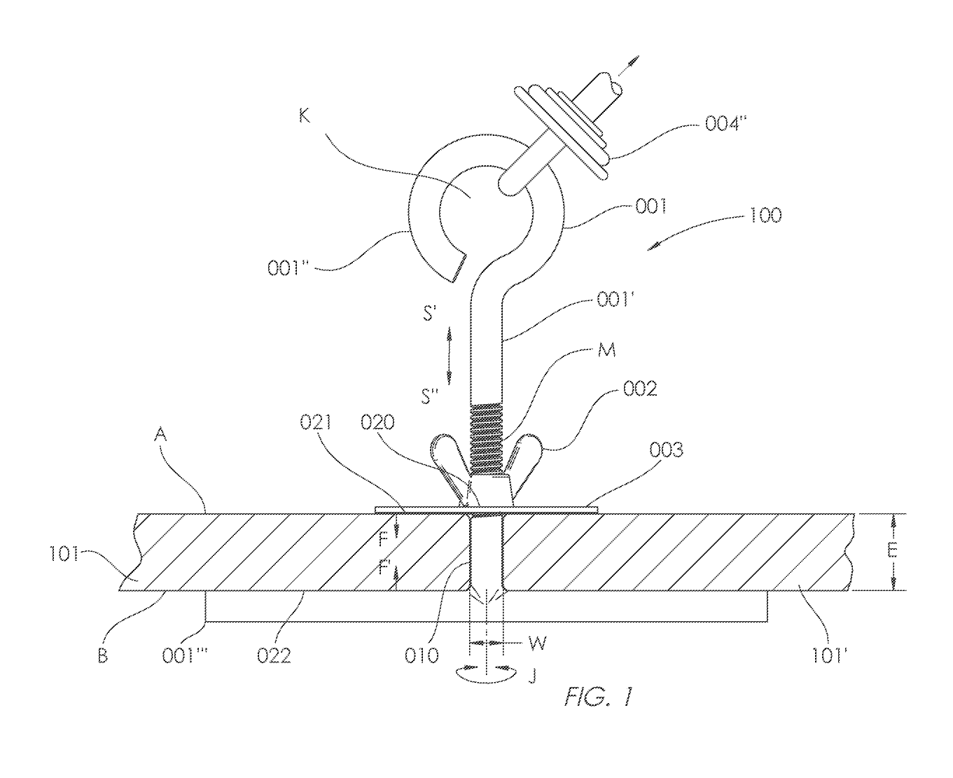

FIGS. 1-8 depict an exemplary embodiment of the invention in which it is desired to secure an item on a surface. In the example shown in the figures and described herein, the surface is depicted as the upper surface of a dock or deck fabricated from, for example, lumber comprising deck boards. Such deck boards may be of dimension E. An exemplary, typical value for dimension E is between 1 and 1.5 inches, but it is to be understood that the scope of the invention is not limited to this value for dimension E, nor is the invention limited to being applied to decks, docks, or wooden structures. Thus the invention may be applied to any structure having a surface A upon which it is desired to secure an item, whether that structure is fabricated from wood, steel, concrete or any other structural material. It is only required that the structure comprise an opening 010 having a width W through which it is possible to pass lower elongate member 001′″ such that, when lower elongate member 001′″ is passed through opening 010, it can be rotated as shown by arrows A so as to retain the anchor against the structure as herein shown and described. An exemplary description of opening 101 is that it could be the opening between deck boards forming a deck, dock or similar structure. Opening 010 may also be any elongate opening in any type of structure. In other words, the structure to which it is desired to secure an item is not limited to comprising deck or dock boards. It is also not intended that the structure to which it is desired to secure an item be a limitation of the claims.

Referring now to FIG. 1, an exemplary embodiment of an anchor of the invention is depicted. Anchor 001 may comprise a first end having a tension member attachment 001″ and a second end connected having an lower elongate member 001′ connected by an elongate body 001′. Tension member attachment 001″ may comprise an opening K for receiving an end of a tension member 004 which may have a hook, carabiner or other feature adapted to releasably attach tension member 004 to tension member attachment 001″ by passing through opening K or by any other attachment means known in the art. Elongate body 001′ may comprise a male threaded portion M to receive tightening member 002 in a threaded engagement, enabling tightening member 002 to be translated along elongate body in the direction of arrows S and S′. In this manner, tightening member 002 may be translated in the direction of S″ for tightening anchor 100 against a surface A surface or substrate. Anchor 001 may further comprise a lower elongate member 001′″ of dimension T that is less than the dimension of opening W, that is capable of passing through an opening 010 in a deck, dock or other surface or substrate which it is desired secure an item, and, after passing through opening 010, may be rotated as depicted by arrow J such that, once rotated, anchor 001 is prevented from passing back up and through opening 010 as it comes in contact with surface B, which may be a lower surface of a deck, dock or other structure. Lower elongate member 001′″, once thus rotated, operates in conjunction with tightening member 002 to capture anchor 001 against surfaces A and B of a dock, deck or other structure, and, as tightening member 002 is rotated in its threading engagement with elongate body 001′ compressive forces F and F′ are applied between either surface 020 of tightening member 002 or surface 021 of optional load spreader 003 against surface A and surface 022 of lower elongate member 001′″ against surface B, securing anchor 100 in place against the structure 101 of the deck or dock. In a preferred embodiment, tightening member 002 is able to be tightened without the use of tools and thus may comprise features that allow finger or hand tightening. One exemplary embodiment of tightening member 002 is a wingnut as is depicted in the figures of the drawings. However it is to be understood that tiny member 002 may be any structure capable of threading engagement with elongate body 001′. Anchor 100 is thus prevented from translating in any direction as it is secured is described the amount of compressive forces F and F′ may be adjusted so as to apply a desired load by rotation of tightening member 002 and it's threaded engagement with elongate body 001′. The structure upon which it is desired to secure an item may comprise boards or other structures 101 and 101′, which may themselves be of thickness E. It is not necessary that structures 101 and 101′ be of the same thickness E. Structures 101 and 101′ may be, for example, boards making up a deck, dock or other structure.

Opening W may be any dimension, but in a preferred embodiment opening W may be less than any outer dimension of load spreader 003, preventing anchor assembly 100 from passing through opening W and thus preventing accidental loss of anchor assembly 100. In a typical, exemplary, non-limiting example, opening W may be on the order of 0.125 inches to 0.250 inches; and thus T may be less than 0.125 or less than 0.250 in specific embodiments

When it is desired to use anchor assembly 100, lower elongate member 001′″ is passed through opening 010 and rotated in either direction of arrow J. Tightening member 002 is rotated along its threaded engagement with elongate body 001′ such that it is translated towards lower elongate member 001′″. In the exemplary embodiment between the figures, the translation of tightening member 002 is in the downward direction. However, it is not necessary that anchor assembly 001 be any particular orientation relative to the force of the Earth's gravity. Once a desired compressive force F and F′ have been achieved by tightening member 002, anchor assembly 100 is ready to be used to secure an item against surface A as described herein. The engagement between anchor assembly 100 and structure 101 and 101′ is a releasable engagement. When it is desired to release anchor assembly 100 from structure 101 and 101′ so that it can be removed or re-located, tightening member 002 is rotated along its threaded engagement with elongate body 001′ so as to relax compressive forces F and F′, allowing lower elongate member 001′ to be rotated such that lower elongate member 001′″ may be rotated and may then be passed through opening 010, allowing anchor assembly 100 to be removed from structures 101 and 101′.

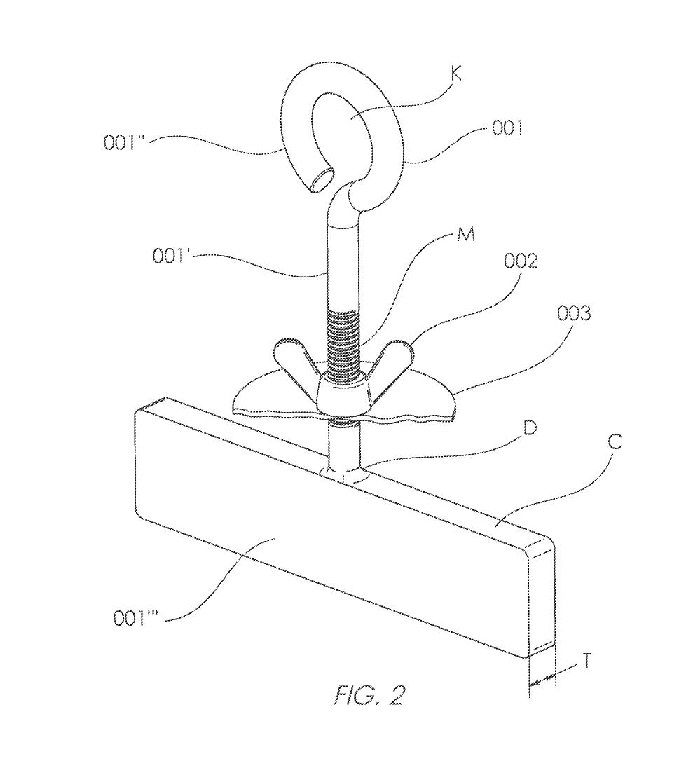

Referring now to FIG. 2, a perspective view of an embodiment of an anchor assembly 100 of the invention is depicted. In this figure, anchor assembly 100 is depicted in an uninstalled condition; in other words, the structure to which the anchor would be attached in order to secure an item is not depicted. Anchor 001 is comprised of elongate body 001′, tension member attachment 001″ having an opening K for hook or other attachment of a tension member 004 (not depicted in FIG. 2), and lower elongate member 001′″. Male threaded portion M is also depicted. Male threaded portion M may extend the entire length of the elongate body 001′ or may extend along only a portion of the long gate body 001′ Anchor 001 may be fabricated from any material that is of sufficient tensile strength to accept a load applied to tension member attachment 001″. As a non-limiting example, such loads may be between 25 to 100 pounds in certain applications such as anchoring a deck chair to the upper surface of a deck or dock in the presence of strong winds. Anchor 001 may be fabricated, for example, from metal or plastic or any other suitable material. In an embodiment, anchor 001 may be fabricated from stainless steel, and anchor body 001′ may be welded to lower elongate member 001′″ at D. Likewise, tightening member 002 and load spreader 003 may also be fabricated from metal, plastic or any other suitable material. In an embodiment, tightening member 002 and load spreader 003 may be fabricated from stainless steel. In other embodiments, anchor 001 may be forged, cast, molded, fabricated by machining, welded of alternative materials or otherwise made in any fashion, and of any material, known in the mechanical arts. In a preferred embodiment, anchor 001 may comprise non-corrosive materials. Surface C of lower elongate member 001′ may be the surface that comes into contact with a surface of structure 101 or 101′ as depicted in FIG. 1 as anchor assembly 100 is tightened into place by the rotation of tightening member 002. Lower elongate member 001′″ may be of maximum width T, which may be less than W depicted in FIG. 1, allowing lower elongate member 001′″ to pass through opening 010 in the structure to which it is desired to secure an item as depicted in FIG. 1. The embodiment of the anchor put it in FIG. 2 comprises a stainless steel eyebolt forming elongated body 001′ and tension member attachment 001″ welded to stainless steel bar stock forming lower elongate member 001′″. However it is to be understood that this is simply one exemplary embodiment of the anchor of the invention.

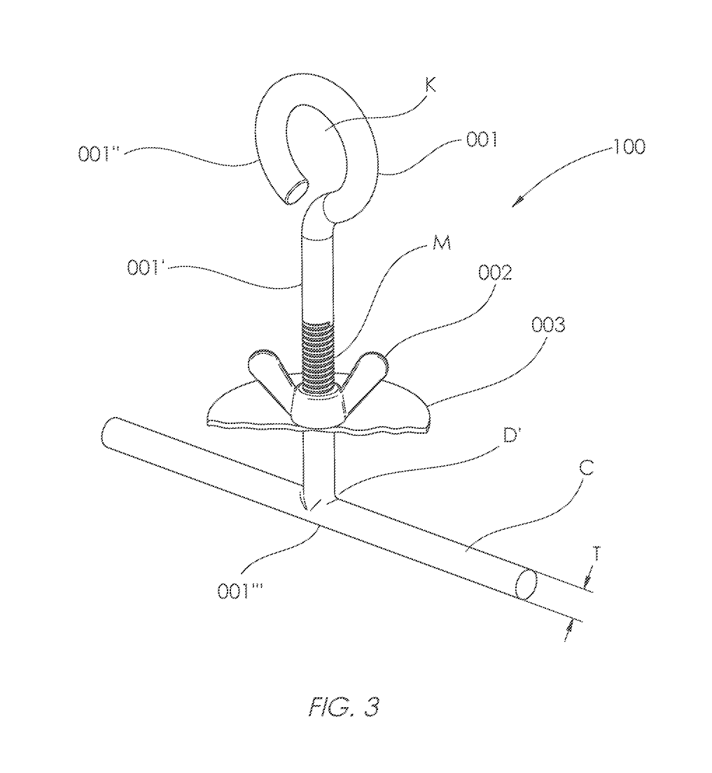

Referring now to FIG. 3, a perspective view of an alternate embodiment of an anchor 001 of an anchor assembly 100 the invention is depicted. In the embodiment of anchor 001 depicted in FIG. 3, lower elongate member 001′″ may be fabricated from round stock of diameter no greater than T, such as stainless steel round stock, and may be welded to elongate body 001′ at D. Tension member attachment 001″ having opening K for attachment of a tension member 004, elongate body 001′, male threaded portion M, tightener 002, load spreader 003, and surface C are shown for reference.

Referring now to both FIGS. 2 and 3, it can be seen that the anchor assembly 100 of the invention is prevented from accidental loss by falling through opening W (depicted in FIG. 1) due to the fact that load spreader 003 may have an outer dimension that is greater than opening gap W in all directions, preventing anchor assembly 100 from passing completely though opening W. and thus preventing loss of anchor assembly 100 whether or not tightening member 002 has been tightened against load spreader 003.

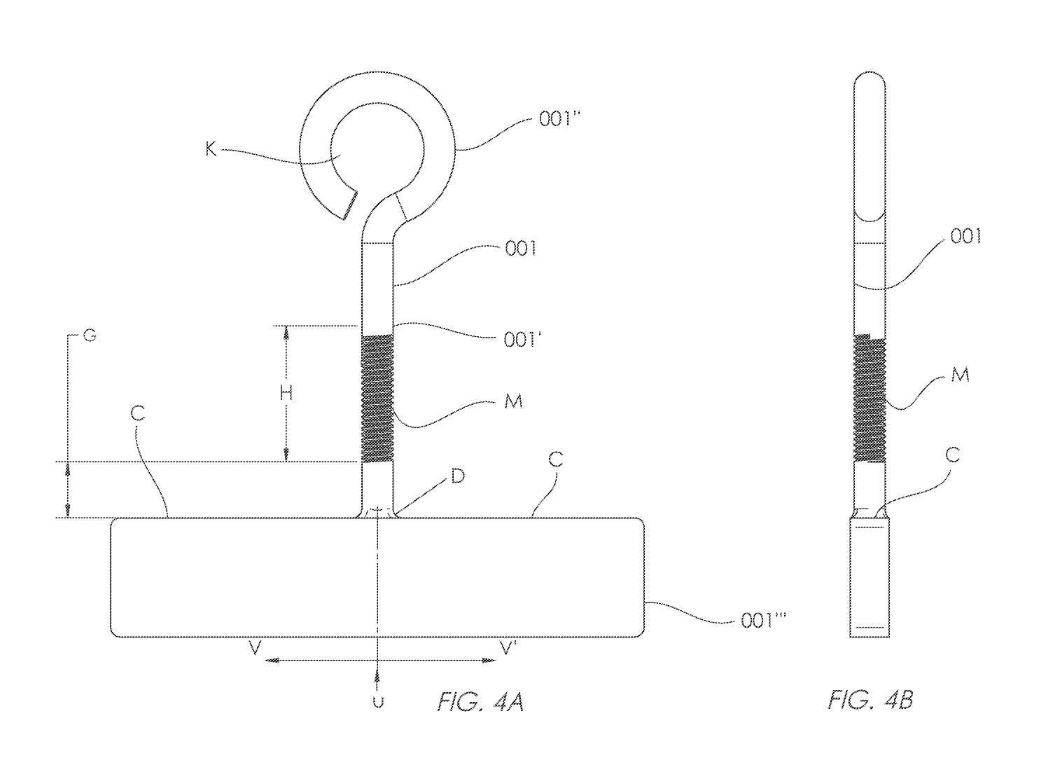

Referring now to FIGS. 4A and 4B, orthogonal views of an embodiment of the anchor of the invention 100 are depicted in which anchor 100 comprises a stainless steel eyebolt forming elongated body 001′ and tension member attachment 001″ which is welded to stainless steel bar stock forming lower elongate member 001′″. Male threaded portion M may extend the entire length of elongate body 001″, or may extend for only a portion of the length of elongate body 001′ depicted as distance H. Elongate body 001′ may have an unthreaded portion extending over distance G. In such cases, distance G may be less than distance D defining the width of structures 101 and 101′ as depicted in FIG. 1. Distance H may be the distance required to allow travel of tightener 002 along elongate body 001′ in the directions of S and S′ as shown in FIG. 1 so as to allow tightening and loosening of as anchor to tightener 002 to allow securing of the anchor assembly 100 against structures 101 and 101′ and to allow release and removal of the anchor assembly from structures 101 and 101′ as shown and described herein relative to FIG. 1. Surface C and weld point D (for those embodiment that are welded) are shown for reference.

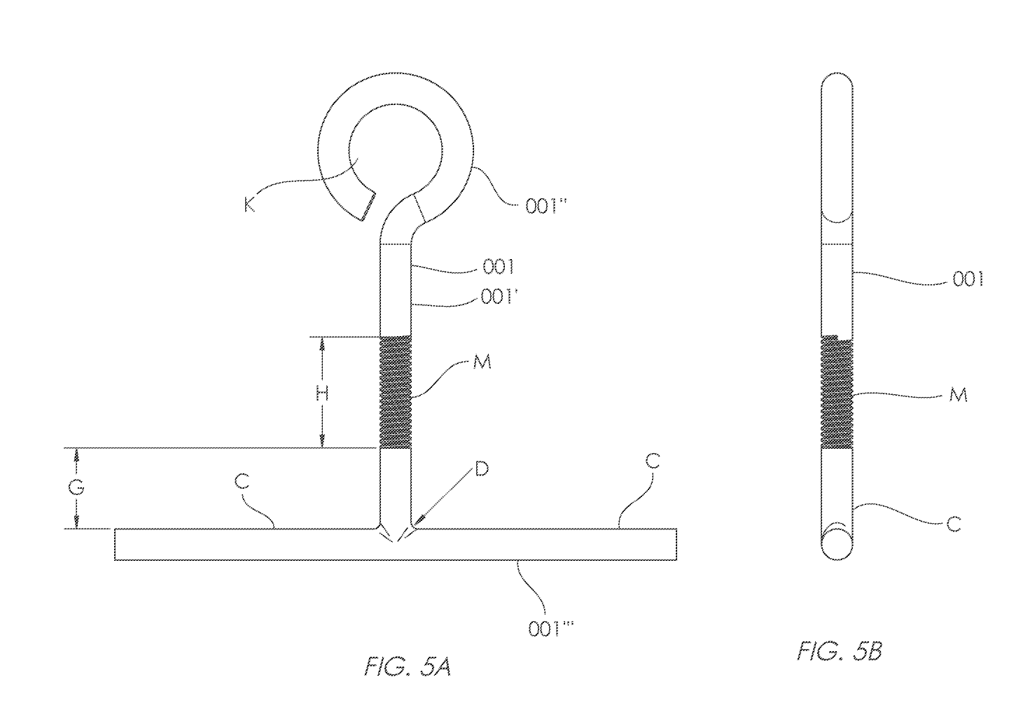

Referring now to FIGS. 5A and 5B, orthogonal views of an alternate embodiment of the anchor of the invention 100 are depicted in which anchor 100 comprises a stainless steel eyebolt forming elongated body 001′ and tension member attachment 001″ that is welded to stainless steel round stock forming lower elongate member 001″. Male threaded portion M may extend the entire length of elongate body 001″, or may extend for only a portion of the length of elongate body 001′ depicted as distance H. Elongate body 001′ may have an unthreaded portion extending over distance G. In such cases, distance G may be less than distance E defining the thickness of structures 101 and 101′ as depicted in FIG. 1. Distance H may be the distance required to allow travel of tightener 002 along elongate body 001′ in the directions of S and S′ as shown in FIG. 1 so as to allow tightening and loosening of as anchor to tightener 002 to allow securing of the anchor assembly 100 against structures 101 and 101′ and to allow release and removal of the anchor assembly from structures 101 and 101′ as shown and described herein relative to FIG. 1. Surface C and weld point D (for those embodiments that are welded) are shown for reference.

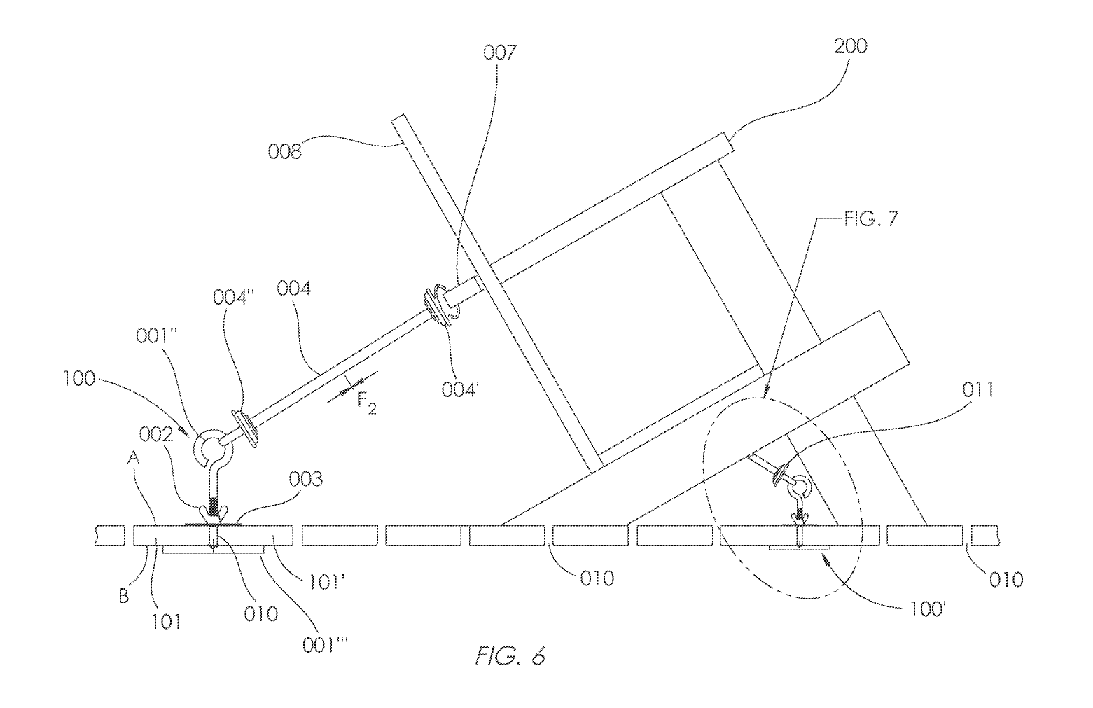

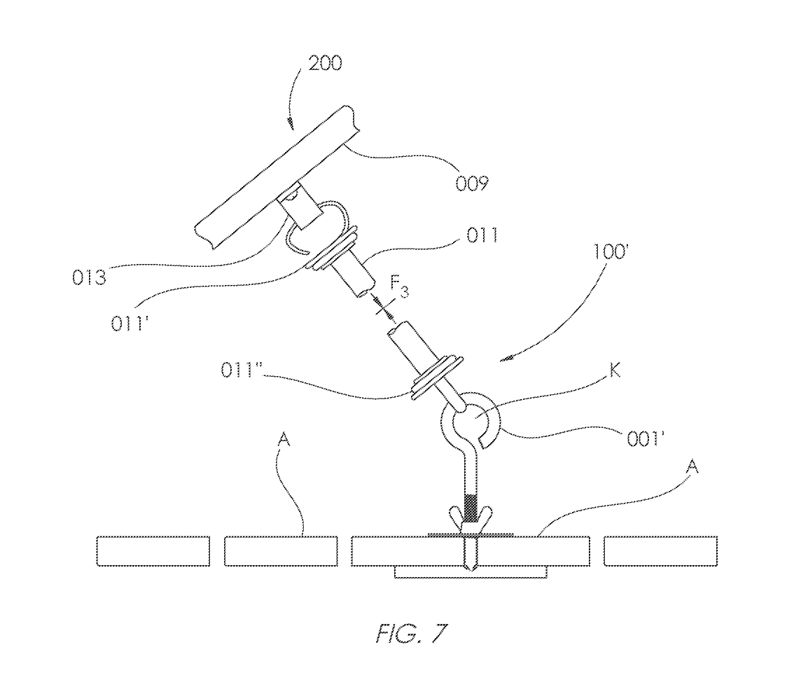

Referring now to FIG. 6, a side view of the anchor system of the invention in an exemplary use case, securing a deck chair to the upper surface of a deck or dock, is depicted. In the exemplary case depicted in FIG. 6, deck chair 200 is secured against surface A of a dock or deck. In the exemplary case shown, surface A is the upper surface of the dock or deck. One or more anchor systems of the invention may be utilized to secure items such as the chair 200 surface of A. As a non-limiting example, a plurality of anchor systems of the invention are depicted in FIG. 6, including a first anchor system comprising anchor assembly 100 and a second anchor system comprising anchor assembly 100′. As is depicted in FIG. 6 and elsewhere herein, first anchor assembly 100 is attached to structures 101 and 101′ by tightening tightener 002 against load spreader 003 causing compressive forces between load spreader 003 and lower elongate member 001′″ against surfaces A and B of structures 101 and 101′. Tension member 004 is attached by a releasable hook or other attachment to tension member attachment 001″ of anchor assembly 100 on a first end 004″, and is attached to bracket 007 in a releasable hook attachment on a second end 004′. The hook attachment herein shown and described may be accomplished by a carabiner, hook shaped member, snap shackle, or any equivalent structure known in the arts. In the case in which tension member 004 is comprised of elastic material, the length of tension member 004 is such that a desired tension force F₂ is applied to tension member attachment 001″ of anchor assembly 100 and bracket 007, which may be attached to any surface, but preferably a rear surface 008, of deck chair 200. Alternatively, in those embodiments in which tension member 004 is non-elastic material such as strap, rope, cable, chain, or other structure with adjustable tension, the adjustable tension is adjusted so as to provide a desired tension force F₂ for securing deck chair 200 to surface A. Gap 010 in surface A between deck boards is shown for reference. Likewise, an underneath surface of deck chair 200 is secured to surface A using a second tension member 011 and second anchor assembly 100′, which is depicted in more detail in FIG. 7.

Referring now to FIG. 7, an expanded view of an embodiment of the anchor system of the invention in a typical use securing a deck chair to the upper surface of a deck or dock, and depicting in larger detail the anchor system of the invention attachment to a lower surface 009 of a seat of the deck chair 200 is depicted. A second anchor assembly 100′ may be attached to structures 101 and 101′ as described elsewhere herein, and tensioning member 011 may be used to secure and underneath surface 009 of deck chair 200 to surface a as depicted in FIG. 7. Tension member 011 may be any tension member as described herein having a first tend 011″ releasably attached to tensioned member attachment 001′ and a hooked attachment through opening K or by any other means as described herein as known in the art. Likewise tensioning member 011 may have a second end 011′ releasably attached in a hook or other attachment to bracket 013 which may be secured to surface 009 of deck chair 200. One or more anchor systems of the invention may be utilized in this manner to secure deck chair 200 to a surface A.

Referring now to FIGS. 6 and 7, one or more anchor systems of the invention may be utilized to attach any surface of deck chair 200 to surface A resulting in a number of tension forces offsetting one another and securing deck chair 200 to surface A such that it is not displaced when acted upon by environmental or other forces such as wind, waves, or rain. While two anchor systems are depicted in FIGS. 6 and 7, one or any number, of anchor systems may be used to secure an item to surface A. Furthermore, it can be seen that the anchor and anchor system of the invention allow for the rotation of deck chair 200, or other items to be secured to a surface, in order to position it at an advantageous orientation relative to the sun or wind, or to take advantage of a particular view of the environment, without the use of any tools, any repositioning of the anchors, by simply lifting deck chair 200 against the force of the tension member(s), rotating deck chair 200 into a desired orientation, and returning deck chair 200 to rest on deck surface A.

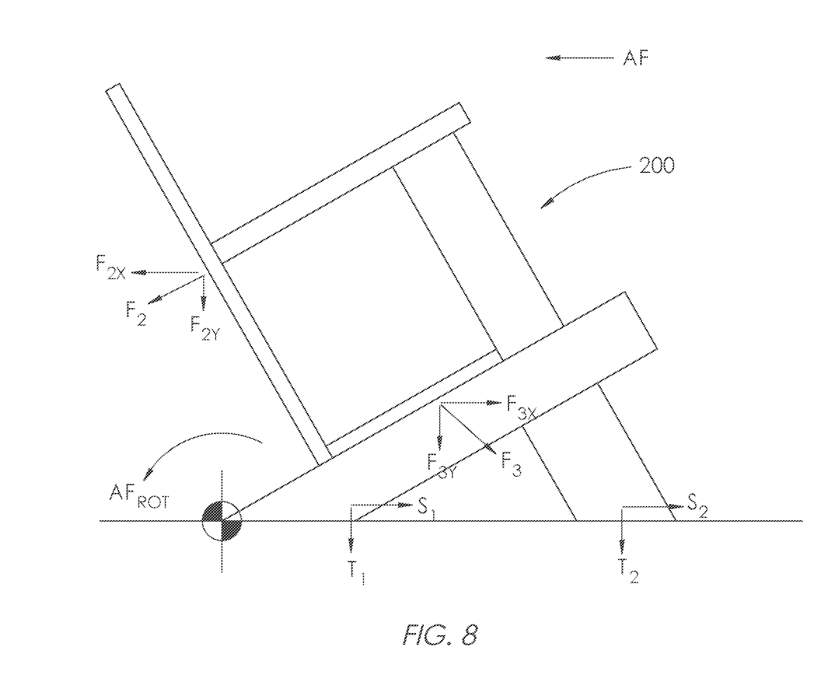

Referring now to FIG. 8, an exemplary force diagram is depicted for the exemplary, non-limiting use case depicted in FIGS. 6 and 7. Tension forces F′2 and F′3 are created by the tension in tension members 004 and 011, respectively. These forces are resolved into vertical and horizontal force components F′2x and F′2y, and F′3x and F′3y.

The vertical force components F′2y and F′3y act together with the weight of deck chair 200 to provide resistance to any force acting on deck chair 200 that attempts to slide the chair on surface A. Resistive forces S1 and S2 result from the downward forces T1 and T2. The coefficient of friction between the lower surfaces of the deck chair legs and surface A combine with forces T1 and T2 to provide resistive forces S1 and S2 that operate to counteract an applied translating force. Thus, deck chair 200 is prevented from sliding or translating across surface A when acted upon by a translating force. Likewise, in the case in which a force AF is applied to deck chair 200, a moment on deck chair that applies a rotating force AFROT about rotation point ROT is created. This rotating moment AFROT is counteracted by horizontal force component F′3x, preventing deck chair 200 from rotating or flipping. It can be seen that a plurality of anchor systems may be attached to a deck chair to counteract translating and rotating forces acting upon deck chair 200 from any direction, and deck chair 200 is thus secured to surface A.

1. An anchor assembly for securing items to a surface, comprising:
an elongate body having an axis, a first end and a second end, wherein said first end comprises an attachment member and said second end comprises a lower elongate member extending away from said elongate body axis;
said elongate body further comprising a male threaded portion;
further comprising a tightening member having an opening therethrough, said opening comprising female threads for threading engagement with said tightening member; wherein said tightening member is threadingly engaged with said male threaded portion of said elongate body such that, when said lower elongate member is inserted into and through a gap in a structure, said tightening member may be translated along said threading engagement in the direction of said structure and tightened against said structure or tightened against an intervening solid load spreader having a first surface and a second surface, said first surface in contact with said tightening member, and said second surface in contact with said structure.

2. The anchor assembly of claim 1, wherein said lower elongate member is further defined as extending away from said axis bilaterally.

3. The anchor assembly of claim 1, wherein said attachment member is further defined as comprising an eye for attaching a tensioning member having a hook attachment.

4. The anchor assembly of claim 1, wherein said tightening member is further defined as a wing nut.

5. The anchor assembly of claim 1, further comprising a load spreader disposed between said lower elongate member and said tightening member.

6. The anchor assembly of claim 1, wherein said elongate body, said attachment member and said elongate lower member are each further defined as being stainless steel.

7. The anchor assembly of claim 6, wherein said elongate body is attached to said attachment member by welding, and wherein said elongate body and said lower elongate member are attached to one another by welding.

8. The anchor assembly of claim 1, wherein said elongate body and said lower elongate member are each defined as having a width, said elongate body width and said lower elongate member width being less that the opening between deck boards forming said surface.

9. The anchor assembly of claim 8, further comprising a load spreader disposed between said lower elongate member and said tightening member;
wherein said wherein said attachment member is further defined as comprising an eye for attaching a tensioning member having a hook attachment; and
wherein said tightening member is further defined as a wing nut;
wherein said elongate body, said attachment member and said elongate lower member are each further defined as being stainless steel;
wherein said elongate body is attached to said attachment member by welding, and wherein said elongate body and said lower elongate member are attached to one another by welding; and
wherein said elongate body and said lower elongate member are each defined as having a width, said elongate body width and said lower elongate member width being less that the opening between deck boards forming said surface.

10. The anchor assembly of claim 2, further comprising a load spreader disposed between said lower elongate member and said tightening member;
wherein said wherein said attachment member is further defined as comprising an eye for attaching a tensioning member having a hook attachment; and
wherein said tightening member is further defined as a wing nut;
wherein said elongate body, said attachment member and said elongate lower member are each further defined as being stainless steel;
wherein said elongate body is attached to said attachment member by welding, and wherein said elongate body and said lower elongate member are attached to one another by welding; and
wherein said elongate body and said lower elongate member are each defined as having a width, said elongate body width and said lower elongate member width being less that the opening between deck boards forming said surface.

11. An anchor system for securing items to a surface, comprising:
At least one anchor assembly having an elongate body having an axis, a first end and a second end, wherein said first end comprises an attachment member and said second end comprises a lower elongate member extending away from said elongate body axis along an axis that is substantially transverse to said elongate body axis; said elongate body further comprising a male threaded portion, said anchor assembly further comprising a tightening member having an opening therethrough, said opening comprising female threads for threading engagement with said male threaded portion of said tightening member, and said tightening member threadingly engaged with said male threaded portion of said elongate body, wherein said lower elongate member is adapted to pass through a gap between said two structures and to be tightened against said a structure comprising a gap by rotating said lower elongate member away from alignment with said gap and translating said tightening member by rotation of said tightening member in said threading engagement until said tightening member is tightened against said structure; and
at least one tensioning member having a first end and a second end, said first end adapted to attach to said attachment member of said anchor in a first attachment, and said second end adapted to attach to an attachment member disposed on an object to be secured in a second attachment; and
wherein said at least one tensioning member provides a force resistive to a force applied to the object to be secured, preventing object to be secured from translating due to the applied force, when said anchor assembly is secured to a structure having a surface, said tension member first end is attached to said attachment member of said anchor in said first attachment, and said tension member second end is attached to said attachment member disposed on the object to be secured in said second attachment, and a desired tension is present in said tension member.

12. The anchor system of claim 11, wherein said first attachment and said second attachment are each further defined as a releasable attachment.

13. The anchor system of claim 11, wherein said tensioning member is further described as comprising elastic material.

14. The anchor system of claim 11, wherein said tensioning member is further described as comprising non-elastic material.

15. The anchor system of claim 11, wherein said at least one anchor assembly is further defined as a plurality of anchor assemblies, and wherein said at least one tensioning member is further defined as a plurality of tensioning members, and wherein at least one tensioning member is attached to each anchor assembly.
